(19) United States
(12) Patent Application Publication
(10) Pub. No.: US 2022/0124659 A1
(43) Pub. Date: Apr. 21, 2022

(54) TIME OF ARRIVAL BASED TIMING ADVANCE CHANGE DETECTION

(71) Applicant: TELEFONAKTIEBOLAGET LM ERICSSON (PUBL), STOCKHOLM (SE)

(72) Inventors: Olof Liberg, ENSKEDE (SE); Johan Bergman, STOCKHOLM (SE); Emre Yavuz, STOCKHOLM (SE); Andreas Höglund, SOLNA (SE)

(21) Appl. No.: 17/427,881

(22) PCT Filed: Feb. 3, 2020
(86) PCT No.: PCT/IB2020/050839

§ 371 Date: Aug. 2, 2021

Related U.S. Application Data
(60) Provisional application No. 62/800,113, filed on Feb. 1, 2019.

(51) Int. Cl. H04W 56/00; H04W 24/10

(52) U.S. Cl. CPC H04W 56/0045; H04W 24/10; H04W 56/001

(57) ABSTRACT

Systems and methods are disclosed herein that relate to determining Timing Advance (TA) value validity in a cellular communications system. In some embodiments, a method performed by a wireless device comprises measuring a reference time of arrival (TOA) value for a reference base station (BS) for a time T₀ at which the wireless device has a valid timing advance, TA(T₀), value, measuring TOA values for a set of other BSs for T₀, and computing and storing time difference of arrival, TDOA_{X}(T₀), values for the other BSs for T₀. The method further comprises measuring a reference TOA value for the reference BS for a time T₁, measuring TOA values for the other BSs for T₁, and computing time difference of arrival, TDOA_{X}(T₁), values for the other BSs for T₁. The method further comprises determining whether the TA(T₀) value is valid at T₁ based on the TDOA_{X}(T₀) and TDOA_{X}(T₁) values.

### RELATED APPLICATIONS

This application claims the benefit of provisional patent application Ser. No. 62/800,113, filed Feb. 1, 2019, the disclosure of which is hereby incorporated herein by reference in its entirety.

### TECHNICAL FIELD

The present disclosure relates to a Timing Advance (TA) in a cellular communications system.

### BACKGROUND

In Release 13, Third Generation Partnership Project (3GPP) developed Narrowband Internet of Things (NB-IoT) and Long Term Evolution (LTE) Machine Type Communication (MTC) (LTE-M). These new Radio Access Technologies (RATs) provide connectivity to services and applications demanding qualities such as reliable indoor coverage and high capacity in combination with low system complexity and optimized power consumption.

A pair of new 3GPP work items for NB-IoT and LTE-M Release 16 have been approved in RP-181450 New WID on Rel-16 LTE-MTC and in RP-181451 New WID on Rel-16 NB-IoT. Both contain objectives to improve the uplink (UL) transmission efficiency in idle mode for devices holding a valid Timing Advance (TA) configuration.

Regarding the TA, before initiating a connection to an LTE-M or NB-IoT network, a device synchronizes its receiver to the downlink (DL) frame structure using, e.g., the (Narrowband) Primary Synchronization Signal ((N)PSS) and (Narrowband) Secondary Synchronization Signal ((N)SSS). After sending an UL (Narrowband) Physical Random Access Channel ((N)PRACH) preamble, the device will, as a response, receive a first DL message containing a TA command that allows the device to adjust the timing of its transmitter to the UL frame structure. The TA value corresponds to the Round Trip Time (RTT), i.e. the time it takes a radio wave to travel from the device to the enhanced or evolved Node B (eNB) and back. A stationary device can hence be expected to receive the same TA configuration across consecutive connection attempts.

In LTE-M and NB-IoT, a device is expected to obtain a fresh TA configuration every time the device makes the transition from idle mode to connected mode. More specifically, the eNB measures the time offset for the reception of the Msg1 preamble for the User Equipment device (UE) and, in the Random Access Response (RAR) in Msg2, informs the UE of the ‘Timing Advance Command’ it should apply from there on for UL transmissions to be received in sync (see 3GPP Technical Specification (TS) 36.321 for further details). At this point, the UE also starts the timer timeAlignmentTimer and will consider the TA as valid as long as this timer is running. In idle mode, the system does not expect the devices to maintain a valid TA configuration.

The TA configuration is set with a granularity of ˜0.5 microseconds (μs). This implies that the smallest change in distance between the eNB and the device that may trigger an update of the TA configuration corresponds to ˜80 meters.

An eNB can tolerate an overall UL timing error that is in the range of the Cyclic Prefix (CP) used in the transmission of the LTE-M and NB-IoT uplink channels. The LTE normal CP typically used is of length 4.7 μs, which implies that a device can at least expect to receive an updated TA configuration after moving ˜700 meters closer, or away, from its serving eNB. The LTE specifications also support an extended CP, which is less prone to UL timing errors at the cost of an increased overhead.

There currently exist certain challenge(s). The objective of the aforementioned NB-IoT and LTE-M Release 16 work items requires a device to maintain a valid TA configuration during idle mode so that the device can transmit UL data in idle mode, e.g. as part of Msg1. If UEs transmit in the UL with incorrect TA, UL subcarrier orthogonality may not be maintained, leading to intra-cell interference. Functionality to support a valid TA configuration in idle mode is missing and must be specified for the Release16 Work Item Descriptions (WIDs) to complete.

### SUMMARY

Systems and methods are disclosed herein that relate to determining the validity of a Timing Advance (TA) value in a cellular communications system. Embodiments of a method of operation of a wireless device and corresponding embodiments of a wireless device are disclosed. In some embodiments, a method performed by a wireless device comprises measuring a reference time of arrival, TOA_{REF}(T₀), value for a reference base station for a time T₀ at which the wireless device has a valid timing advance, TA(T₀), value, measuring time of arrival, TOA_{X}(T₀), values for a set of one or more other base stations {BS_{X}} for the time T₀, and computing and storing time difference of arrival, TDOA_{X}(T₀), values for the set of one or more other base stations {BS_{X}} for the time T₀. The method further comprises measuring a reference time of arrival, TOA_{REF}(T), value for the reference base station for a time T₁, the time T₁ being after the time T₀, measuring time of arrival, TOA_{X}(T₁), values for the set of one or more other base stations {BS_{X}} for the time T₁, and computing time difference of arrival, TDOA_{X}(T₁), values for the set of one or more other base stations {BS_{X}} for the time T₁. The method further comprises determining whether the TA(T₀) value is valid at the time T₁ based on the TDOA_{X}(T₀) values for the set of one or more other base stations {BS_{X}} for the time T₀ and the TDOA_{X}(T₁) values for the set of one or more other base stations {BS_{X}} for the time T₁. In this manner, the wireless device is enabled to determine the TA value validity.

In some embodiments, the time T₁ is a time at which the wireless device is in idle mode.

In some embodiments, determining whether the TA(T₀) value is valid at the time T₁ comprises determining that the TA(T₀) value is valid at the time T₁. Further, in some embodiments, the method further comprises performing an idle mode uplink transmission using the TA(T₀) value upon determining that the TA(T₀) value is valid at the time T₁.

In some embodiments, the time T₀ is a time at which the wireless device checked that its timing advance was valid for providing synchronized uplink access.

In some embodiments, determining whether the TA(T₀) value is valid at the time T₁ comprises computing differential time difference of arrival, dTDOA_{X}(T₁), values for the set of one or more other base stations {BS_{X}} for the time T₁, wherein for each other base station BS_{X} of the set of one or more other base stations {BS_{X}}, the dTDOA_{X}(T₁) value is computed as a difference between the TDOA_{X}(T₁) value for the BS_{X} and the TDOA_{X}(T₀) value for the BS_{X}. Determining whether the TA(T₀) value is valid at the time T₁ further comprises finding a maximum value from among the dTDOA_{X}(T₁) values, or absolute values of the dTDOA_{X}(T₁) values, for the set of one or more other base stations {BS_{X}} for the time T₁, and determining whether the TA(T₀) value is valid at the time T₁ based on the maximum value. In some embodiments, determining whether the TA(T₀) value is valid at the time T₁ based on the maximum value comprises determining whether the maximum value is less than a predefined or configured threshold. In some embodiments, determining whether the TA(T₀) value is valid at the time T₁ based on the maximum value further comprises determining that the TA(T₀) value is valid at the time T₁ if the maximum value is less than the predefined or configured threshold. In some embodiments, determining whether the TA(T₀) value is valid at the time T₁ based on the maximum value further comprises determining that the TA(T₀) value is not valid at the time T₁ if the maximum value is greater than a predefined or configured threshold.

In some embodiments, determining whether the TA(T₀) value is valid at the time T₁ comprises computing differential time difference of arrival, dTDOA_{X}(T₁), values for the set of one or more other base stations {BS_{X}} for the time T₁, wherein for each other base station BS_{X} of the set of one or more other base stations {BS_{X}}, the dTDOA_{X}(T₁) value is computed as a difference between the TDOA_{X}(T₁) value for the BS_{X} and the TDOA_{X}(T₀) value for the BS_{X}. Determining whether the TA(T₀) value is valid at the time T₁ further comprises computing a mean, standard deviation, or variance of the dTDOA_{X}(T₁) values, and determining whether the TA(T₀) value is valid at the time T₁ based on the mean, standard deviation, or variance of the dTDOA_{X}(T₁) values. In some embodiments, determining whether the TA(T₀) value is valid at the time T₁ based on the mean, standard deviation, or variance of the dTDOA_{X}(T₁) values comprises determining whether the mean, standard deviation, or variance of the dTDOA_{X}(T₁) values is less than a predefined or configured threshold. In some embodiments, determining whether the TA(T₀) value is valid at the time T₁ based on the mean, standard deviation, or variance of the dTDOA_{X}(T₁) values further comprises determining that the TA(T₀) value is valid at the time T₁ if the mean, standard deviation, or variance of the dTDOA_{X}(T₁) values is less than the predefined or configured threshold. In some embodiments, determining whether the TA(T₀) value is valid at the time T₁ based on the mean, standard deviation, or variance of the dTDOA_{X}(T₁) values comprises determining that the TA(T₀) value is not valid at the time T₁ if the mean, standard deviation, or variance of the dTDOA_{X}(T₁) values is greater than the predefined or configured threshold.

In some embodiments, the TOA_{REF}(T₀) value is an averaged value over time and/or frequency, the TOA_{X}(T₀) values are averaged values over time and/or frequency, the TOA_{REF}(T₁) value is an averaged value over time and/or frequency; and/or the TOA_{X}(T₁) values are averaged values over time and/or frequency.

In some embodiments, the wireless device is a Narrowband Internet of Things (NB-IoT), User Equipment (UE), a Long Term Evolution Machine Type Communication (LTE-M) UE, or a New Radio (NR) UE.

In some embodiments, a wireless device for a cellular communications system is adapted to measure a reference time of arrival, TOA_{REF}(T₀), value for a reference base station for a time T₀ at which the wireless device has a valid timing advance, TA(T₀), value, measure time of arrival, TOA_{X}(T₀), values for a set of one or more other base stations {BS_{X}} for the time T₀, and compute and store time difference of arrival, TDOA_{X}(T₀), values for the set of one or more other base stations {BS_{X}} for the time T₀. The wireless device is further adapted to measure a reference time of arrival, TOA_{REF}(T₁), value for the reference base station for a time T₁, the time T₁ being a time at which the wireless device is in idle mode, measure time of arrival, TOA_{X}(T₁), values for the set of one or more other base stations {BS_{X}} for the time T₁, and compute time difference of arrival, TDOA_{X}(T₁), values for the set of one or more other base stations {BS_{X}} for the time T₁. The wireless device is further adapted to determine whether the TA(T₀) value is valid at the time T₁ based on the TDOA_{X}(T₀) values for the set of one or more other base stations {BS_{X}} for the time T₀ and the TDOA_{X}(T₁) values for the set of one or more other base stations {BS_{X}} for the time T₁.

In some embodiments, a method performed by a wireless device comprises obtaining a distance that the wireless device has moved between a time T₀ at which the wireless device has a valid timing advance, TA(T₀), value and a time T₁, and determining whether the TA(T₀) value is valid at the time T₁ based on the distance.

In some embodiments, determining whether the TA(T₀) value is valid at the time T₁ comprises determining that the TA(T₀) value is valid at the time T₁. In some embodiments, the method further comprises performing an idle mode uplink transmission using the TA(T₀) value upon determining that the TA(T₀) value is valid at the time T₁.

In some embodiments, determining whether the TA(T₀) value is valid at the time T₁ based on the distance comprises determining whether the distance is less than a predefined or configured threshold. In some embodiments, determining whether the TA(T₀) value is valid at the time T₁ based on the distance further comprises determining that the TA(T₀) value is valid at the time T₁ if the distance is less than the predefined or configured threshold. In some embodiments, determining whether the TA(T₀) value is valid at the time T₁ based on the distance further comprises determining that the TA(T₀) value is not valid at the time T₁ if the distance is greater than the predefined or configured threshold.

In some embodiments, the wireless device is in connected mode at the time T₀ and in idle mode at the time T₁.

In some embodiments, the wireless device is a NB-IoT UE, a LTE-M UE, or a NR UE.

In some embodiments, a wireless device for a cellular communications system is adapted to obtain a distance that the wireless device has moved between a time T₀ at which the wireless device has a valid timing advance, TA(T₀), value and a time T₁, and determine whether the TA(T₀) value is valid at the time T₁ based on the distance.

In some embodiments, a method performed by a wireless device comprises performing an idle mode transmission using a stored TA value. The method further comprises receiving a transmission from a base station that explicitly or implicitly indicates whether the stored TA value is valid, commands the wireless device to acquire a new TA value, or provides a new TA value, and performing one or more operations in accordance with the received transmission.

In some embodiments, performing the idle mode transmission comprises performing the idle mode transmission at a time T₁ at which the wireless device is in idle mode, wherein the stored TA value is a TA value, TA(T₀), obtained by the wireless device at a time T₀ when the wireless device is in connected mode.

In some embodiments, the transmission indicates that the stored TA value is invalid, and performing the one or more operations comprises obtaining a new TA value. In some embodiments, obtaining the new TA value comprises obtaining the new TA value using a random access procedure.

In some embodiments, the wireless device is a NB-IoT UE, a LTE-M UE, or a NR UE.

In some embodiments, a wireless device for a cellular communications system is adapted to perform an idle mode transmission using a stored TA value. The wireless device is further adapted to receive a transmission from a base station that explicitly or implicitly indicates whether the stored TA value is valid, commands the wireless device to acquire a new TA value, or provides a new TA value, and perform one or more operations in accordance with the received transmission.

In some embodiments, a method performed by a wireless device comprises performing an idle mode transmission using a stored TA value, detecting that the idle mode transmission using the stored TA value was unsuccessful, and obtaining a new TA value upon detecting that the idle mode transmission using the stored TA value was unsuccessful.

In some embodiments, obtaining the new TA value comprises obtaining the new TA value using a random access procedure.

In some embodiments, the wireless device is a NB-IoT UE, a LTE-M UE, or a NR UE.

In some embodiments, a wireless device for a cellular communications system is adapted to perform an idle mode transmission using a stored TA value, detect that the idle mode transmission using the stored TA value was unsuccessful, and obtain a new TA value upon detecting that the idle mode transmission using the stored TA value was unsuccessful.

Embodiments of a method performed by a base station and corresponding embodiments of a base station are also disclosed. In some embodiments, a method performed by a base station comprises transmitting, to a wireless device, an indication as to whether the wireless device is to determine TA validity when in idle mode using a TDOA scheme or a distance scheme.

In some embodiments, a method performed by a base station comprises receiving an idle mode transmission from a wireless device, determining whether the wireless device used a valid TA value for the idle mode transmission, and transmitting a transmission to the wireless device that explicitly or implicitly indicates whether a particular TA value is valid, commands the wireless device to acquire a new TA value, or provides a new TA value, based on the determination of whether the wireless device used a valid TA value for the idle mode transmission.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is an illustration of Time Difference Of Arrival (TDOA) based on the reception of reference signals (RS A and B) transmitted from base stations (enhanced or evolved Node B (eNB) A and B);

FIG. 2 illustrates one example of a cellular communications system in which embodiments of the present disclosure may be implemented;

FIGS. 3 and 4 are flow charts that illustrate the operation of a device in accordance with at least some aspects of a first embodiment of the present disclosure;

FIG. 5 is a flow chart that illustrates the operation of a device in accordance with at least some aspects of a second embodiment of the present disclosure;

FIG. 6 is a flow chart that illustrates the operation of a device in accordance with at least some aspects of a third embodiment of the present disclosure;

FIG. 7 illustrates the operation of a base station and a device in accordance with at least some aspects of a fourth embodiment of the present disclosure;

FIG. 8 illustrates the operation of a base station and a device in accordance with at least some aspects of a fifth embodiment of the present disclosure;

FIG. 9 illustrates the operation of a base station and a device in accordance with at least some aspects of a sixth embodiment of the present disclosure;

FIGS. 10, 11, and 12 are schematic block diagrams of example embodiments of a radio access node (e.g., a base station);

FIGS. 13 and 14 are schematic block diagrams of example embodiments of a wireless device;

FIG. 15 illustrates another example of a system in which embodiments of the present disclosure may be implemented;

FIG. 16 illustrates example embodiments of the host computer, base station, and User Equipment (UE) of FIG. 15; and

FIGS. 17, 18, 19, and 20 are flow charts illustrating methods implemented in a communication system, in accordance with some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless device.

Radio Access Node: As used herein, a “radio access node” or “radio network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment (UE) in a 3GPP network and a Machine Type Communication (MTC) device.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

As discussed above, there currently exist certain challenge(s) related to a wireless device (e.g., a Narrowband Internet of Things (NB-IoT) UE or LTE MTC (LTE-M) UE) maintaining a valid Timing Advance (TA) value while in idle mode. More specifically, the objective of the aforementioned NB-IoT and LTE-M Release 16 work items requires a UE to maintain a valid TA configuration during idle mode so that the device can transmit uplink (UL) data in idle mode, e.g. as part of Msg1. If UEs transmit in the UL with incorrect TA, UL subcarrier orthogonality may not be maintained, leading to intra-cell interference. Functionality to support a valid TA configuration in idle mode is missing and must be specified for the Release16 Work Item Descriptions (WIDs) to complete.

Certain aspects of the present disclosure and their embodiments may provide solutions to the aforementioned or other challenges. A device that is stationary, or of low mobility, can be expected to experience a limited change in the Time Difference of Arrival (TDOA) of two or more reference signals received from two or more base stations.

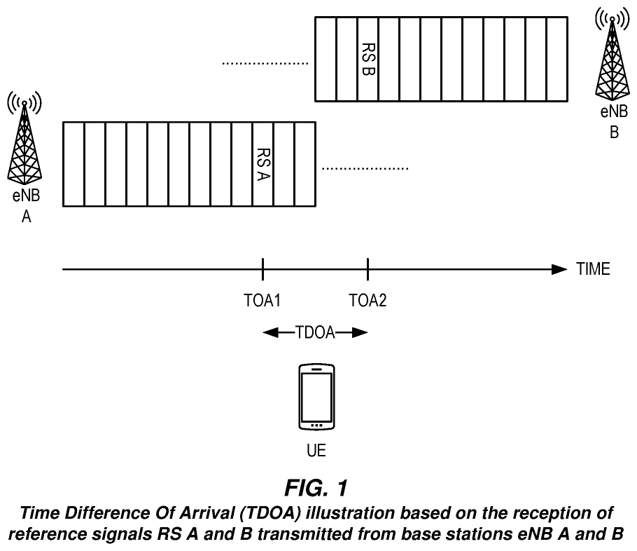

FIG. 1 illustrates a UE that receives Reference Signals (RSs) A and B transmitted from base stations (eNBs) A and B. Based on the Time of Arrival (TOA) of each of these reference signals, the UE can compute the TDOA between the two reference signals. As each of the TOAs corresponds to the distance between the respective base station and UE, the TDOA may serve as strong indicator of mobility. A time variant TDOA indicates mobility. A time invariant TDOA indicates low mobility.

This solution provides a simple method for determining if the most recently acquired TA configuration is still valid or needs to be updated.

Certain embodiments may provide one or more of the following technical advantage(s). Embodiments of the present disclosure provide the advantage of allowing devices to perform idle mode UL data transmissions with a valid TA, which reduces eNB receiver complexity.

In the present disclosure, embodiments of a device (i.e., a wireless device such as, e.g., a UE) and methods of operation thereof are proposed for determining the validity of the device's most recent TA configuration based TDOA measurements.

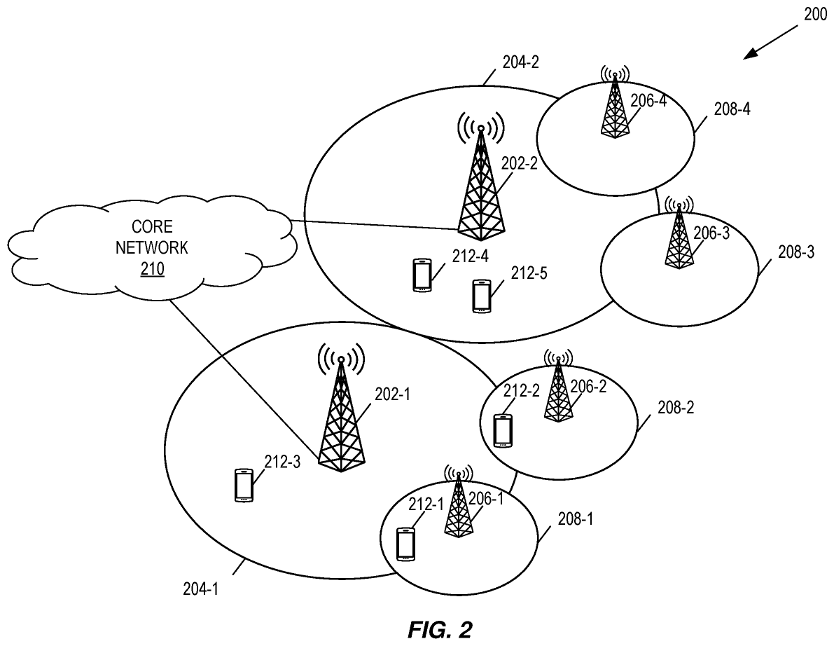

In this regard, FIG. 2 illustrates one example of a cellular communications network 200 in which embodiments of the present disclosure may be implemented. In the embodiments described herein, the cellular communications network 200 is an LTE network or a 5G NR network. The cellular communications network 200 supports one or more Radio Access Technologies (RATs). In the preferred embodiments disclosed herein, the RATs supported by the cellular communications network 200 include NB-IoT and/or LTE-M.

In this example, the cellular communications network 200 includes base stations 202-1 and 202-2, which in LTE are referred to as eNBs and in 5G NR are referred to as gNBs, controlling corresponding macro cells 204-1 and 204-2. The base stations 202-1 and 202-2 are generally referred to herein collectively as base stations 202 and individually as base station 202. Likewise, the macro cells 204-1 and 204-2 are generally referred to herein collectively as macro cells 204 and individually as macro cell 204. The cellular communications network 200 may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The base stations 202 (and optionally the low power nodes 206) are connected to a core network 210.

The base stations 202 and the low power nodes 206 provide service to wireless devices 212-1 through 212-5 in the corresponding cells 204 and 208. The wireless devices 212-1 through 212-5 are generally referred to herein collectively as wireless devices 212 and individually as wireless device 212. The wireless devices 212 are also sometimes referred to herein as UEs. Further, for NB-IoT, the UE(s) 212 operating in accordance with NB-IoT is (are) referred to as NB-IoT UE(s). Likewise, for LTE-M, the UE(s) 212 operating in accordance with LTE-M is(are) referred to as LTE-M UE(s).

In the present disclosure, embodiments of a device (i.e., a wireless device such as, e.g., a UE, a NB-IoT UE, or a LTE-M UE) and methods of operation thereof are proposed for determining the validity of the device's most recent TA configuration based TDOA measurements. In this regard, a number of embodiments will now be described. Note that while described separately, these embodiments may be used separately or used in any desired combination.

### First Embodiment: TDOA Based Detection

In a first embodiment, at time instance T₀, a device holds a valid TA(T₀) configuration. The device measures the TOA (TOA_{REF}) of a reference signal transmitted from the serving cell base station and the TOA (TOA_{X}) of a set of reference signals transmitted from a set of neighbor cell base stations. The device estimates the TDOA (TDOA_{X}(T₀)) between TOA_{REF} and TOA_{X} for the set of neighbor base stations Xϵ{0,1, . . . , N}.

At a second time instance T₁, the device repeats this procedure prior to UL data transmission, e.g., in Msg1 (i.e., Physical Random Access Channel (PRACH) preamble transmission), to derive TDOA_{X}(T₁) and calculates, for each neighbor base station X, a TDOA change value dTDOA_{X}=TDOA_{X}(T₀)−TDOA_{X}(T₁). If the maximum absolute value in the set of dTDOA_{X}, i.e. max(dTDOAx), does not exceed a predefined or configured threshold, e.g. in system information broadcast and/or dedicated signaling, then the device considers its stored TA(T₀) value to be valid to be used for an idle mode UL data transmission, e.g. in Msg1.

In one aspect of the first embodiment, if max(dTDOAx) exceeds the configured threshold, then the device considers its stored TA(T₀) value to be outdated and not valid for use during an idle mode data transmission.

The TOA_{REF} and TOA_{X} measurements are based on one or more physical signal or physical channel transmitted in downlink (DL), for example Primary Synchronization Signal (PSS)/Secondary Synchronization Signal (SSS), Narrowband PSS (NPSS)/Narrowband SSS (NSSS), Resynchronization Signal (RSS), Common Reference Signal (CRS), Narrowband Reference Signal (NRS), or Positioning Reference Signal (PRS).

The TOA_{REF} and TOA_{X} measurements may be averaged in the time or frequency domain to improve the accuracy of the measurements. The required amount of averaging may be determined based on the power or quality of the signal that is used for the measurement.

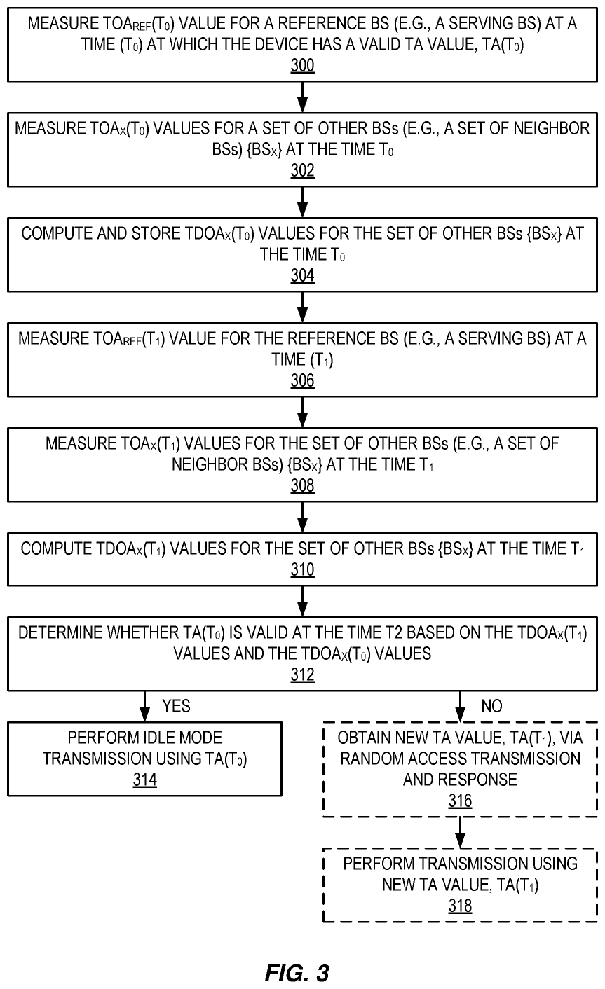

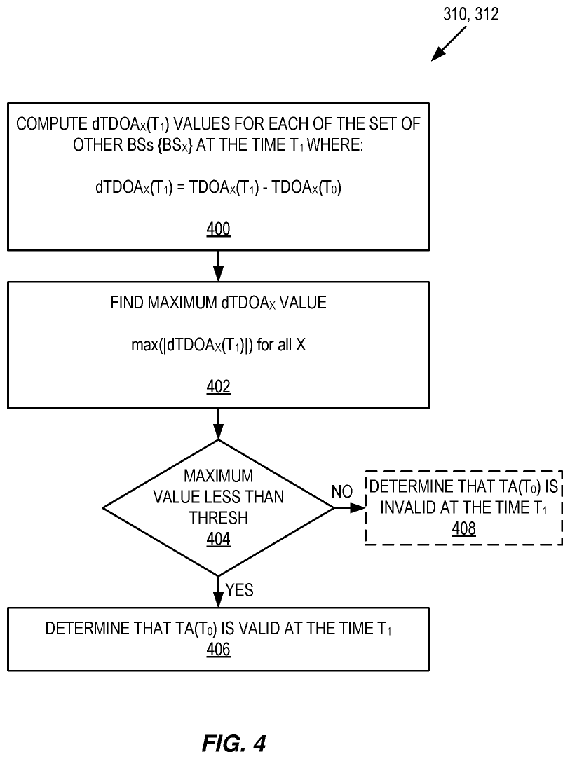

FIGS. 3 and 4 are flow charts that illustrate the operation of a device in accordance with at least some aspects of the first embodiment. As illustrated in FIG. 3, the device (e.g., a wireless device 212 such as an LTE-M UE or NB-IoT UE) measures a reference TOA value at time T₀, which is denoted as TOA_{REF}(T₀) (step 300). As discussed above, the TOA_{REF}(T₀) is measured for a reference base station such as, e.g., a base station of a serving cell of the device. The time T₀ is a time at which the device knows that it has a valid timing configuration, which is denoted here as TA(T₀). More specifically, in some embodiments, the device is in connected mode at time T₀ and obtains the TA(T₀) while in connected mode. The device also measures TOA values for each of a set of other base stations at the time T₀ (step 302). As discussed above, the set of other base stations may be a set of neighbor base stations of the device. These TOA values are denoted as TOA_{X}(T₀) values for the set of base stations {BS_{X}}, where X=1, 2, . . . , N and “N” is the number of base stations in the set. The device computes and stores TDOA values for the set of other base stations at the time T₀ (step 304). These TDOA values are denoted as TDOA_{X}(T₀) values for the set of base stations {BS_{X}}.

In some embodiments, the device obtains a valid TA value at time T₀ (denoted TA(T₀)) while the device is in connected mode. The measurements made in step 300 and 302 may thus be performed while the device is in connected mode.

Sometime thereafter while the device is in idle mode (e.g., after the device transitions from connected mode to idle mode), at a time T₁, the device desires to determine whether TA(T₀) is still valid. For example, the device may desire to determine whether TA(T₀) is still valid at time T₁ before transmitting an idle mode transmission (e.g., a Msg1 transmission for random access). Thus, the device measures a reference TOA value at time T₁, which is denoted as TOA_{REF}(T₁) (step 306). As discussed above, the TOA_{REF}(T₁) is measured for the reference base station of the device. The device also measures TOA values for each of the set of other base stations at the time T₁ (step 308). These TOA values are denoted as TOA_{X}(T₁) values for the set of base stations {BS_{X}}, where X=1, 2, . . . , N and “N” is the number of base stations in the set. The device computes TDOA values for the set of other base stations at the time T₁ (step 310). These TDOA values are denoted as TDOA_{X}(T₁) values for the set of base stations {BS_{X}}.

The device then determines whether the TA(T₀) is still valid at time T₁ based on the TDOA_{X}(T₁) values and the TDOA_{X}(T₀) values (step 312). If the TA(T₀) is still valid at time T₁, the device performs an idle mode transmission using the TA(T₀) (step 314). Optionally, as indicated by dashed lines in FIG. 3, if the TA(T₀) is not valid at time T₁, the device obtains a new TA value, TA(T₁), via random access transmission and response, in the conventional manner (step 316) and then performs the desired transmission using the new TA value, TA(T₁) (step 318).

FIG. 4 illustrates steps 310 and 312 in more detail. As illustrated in FIG. 4, in order to determine whether the TA(T₀) is still valid at time T₁, the device computes dTDOA_{X}(T₁) values (step 400) for the set of base stations {BS_{X}} as:

dTDOA_{X}(T₁)=TDOA_{X}(T₁)−TDOA_{X}(T₀).

Step 400 corresponds to step 310 of FIG. 3. The remaining steps of FIG. 4 provide one example implementation of step 312 of FIG. 3. The device finds a maximum dTDOA_{X}(T₁) value from among the computed dTDOA_{X}(T₁) values (step 402). Preferably, as shown in this example, the device considers the absolute values of the dTDOA_{X}(T₁) values then finds the maximum value. The device determines whether the maximum value is less than or equal to a predefined or configured threshold (step 404). In some embodiments, the device may determine whether the maximum value is less than the threshold. If so, the device determines that TA(T₀) is still valid at time T₁ (step 406). The device may then use TA(T₀) to, e.g., perform an idle mode UL transmission (e.g., a Msg1 transmission) at time T₂. Optionally (as represented in FIG. 4 by dashed lines), if the outcome of the decision in step 404 is “no,” the device determines that TA(T₀) is not valid at time T₁ (step 408).

### Second Embodiment: TDOA Based Detection

In a second embodiment, building on the first embodiment, if the mean, the standard deviation, or the variance of the set of calculated dTDOA_{X} does not exceed a configured threshold then the device considers its stored TA(T₀) value to be valid to be used for an idle mode UL data transmission, e.g., in Msg1.

In a first aspect of the second embodiment, if the mean, the standard deviation, or the variance of dTDOA_{X} exceeds the configured threshold, then the device considers its stored TA(T₀) value to be outdated and not valid for use during an idle mode UL data transmission, e.g., in Msg1.

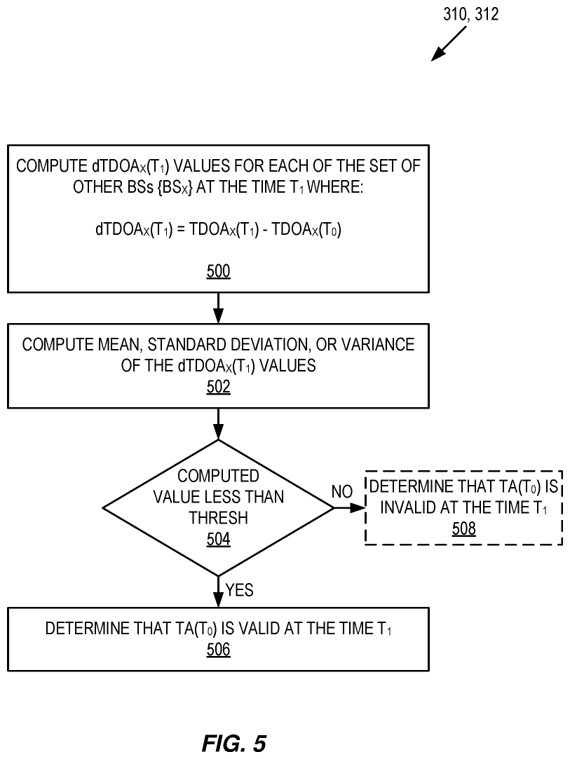

Thus, in one variation of the process of FIGS. 3 and 4, step 402 is replaced with a step of determining the mean, the standard deviation, or the variance of the computed dTDOA_{X}(T₁) values and compares this determined value to a predefined or configured threshold to thereby determine whether the TA(T₀) value is valid at time T₁. More specifically, this is illustrated in FIG. 5. As illustrated, in order to determine whether the TA(T₀) is still valid at time T₁, the device computes dTDOA_{X}(T₁) values for the set of base stations {BS_{X}} (step 500) as:

dTDOA_{X}(T₁)=TDOA_{X}(T₁)−TDOA_{X}(T₀).

The device computes the mean, standard deviation, or variance of the dTDOA_{X}(T₁) values (step 502). The device determines whether the computed value from step 502 is less than or equal to a predefined or configured threshold (step 504). In some embodiments, the device determines whether the computed value is less than the threshold. If so, the device determines that TA(T₀) is still valid at time T₁ (step 506). The device may then use TA(T₀) to, e.g., perform an idle mode UL transmission (e.g., a Msg1 transmission) at time T₂. Optionally (as represented in FIG. 5 by dashed lines), if the outcome of the decision in step 504 is “no,” the device determines that TA(T₀) is not valid at time T₁ (step 508).

### Third Embodiment: Global Positioning System (GPS) Based Detection

In a third embodiment, the device is equipped with a GPS, or other non-cellular positioning system, and detects the distance d that the device has travelled between time instances T₀ and T₁. If d is below a configured or predetermined fixed threshold (e.g., predefined fixed threshold in the specifications), then then the device considers its stored TA(T₀) value to be valid to be used for an idle mode UL data transmission, e.g., in Msg1, at time T₁.

In a first aspect of the third embodiment, if d exceeds the configured threshold, then the device considers its stored TA(T₀) value to be outdated and not valid for use during an idle mode data transmission.

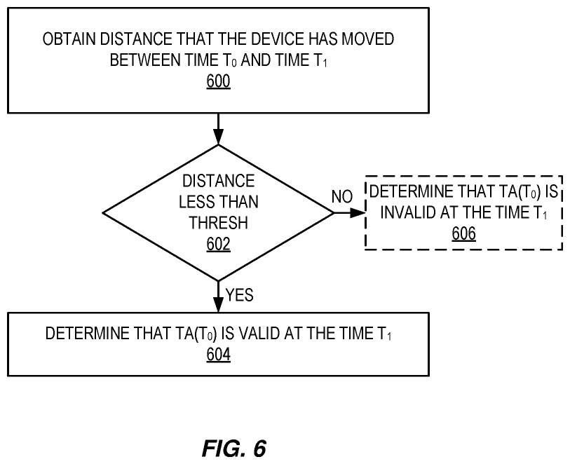

One example of the third embodiment is illustrated in FIG. 6. As illustrated, the device obtains a distance (d) that the device has moved between a time T₀ at which the device had a valid timing configuration TA(T₀) and a time T₂ (step 600). The device determines whether the distance is less than or equal to a predefined or configured threshold (step 602). If so, the device determines that TA(T₀) is still valid at time T₁ (step 604). The device may then use TA(T₀) to, e.g., perform an idle mode UL transmission (e.g., a Msg1 transmission) at time T₂. Optionally (as represented in FIG. 6 by dashed lines), if the outcome of the decision in step 602 is “no,” the device determines that TA(T₀) is not valid at time T₁ (step 606).

### Fourth Embodiment: Configuration

In a fourth embodiment, building on the previous embodiments, the base station (e.g., eNB) indicates, either through broadcast, multicast, or unicast signaling, that devices may perform the methods described in the previous embodiments. This signaling may also indicate the threshold to be used by the UE for confirming the TA validity.

In an aspect of the fourth embodiment, the base station (e.g., eNB) indicates either through broadcast, multicast, or unicast signaling which neighbor cells that should be used in the method described in the first embodiment and/or the second embodiment.

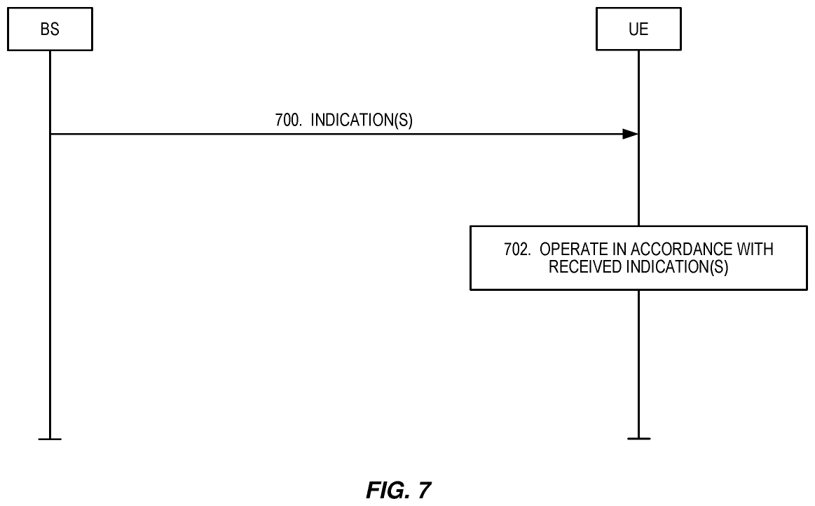

FIG. 7 illustrates the operation of a base station (e.g., eNB) and a device (e.g., a UE) in accordance with at least some aspects of the fourth embodiment. As illustrated, the base station sends, either through broadcast, multicast, or unicast signaling, an indication that the device may perform the methods described in the previous sections (step 700). This signaling may also indicate the threshold to be used by the UE for confirming TA validity. In another aspect, the base station may also indicate (e.g., in the signaling of step 700) which neighbor cells that should be used in the method described in the first embodiment and/or the second embodiment. The device then operates in accordance with the received indication (step 702).

### Fifth Embodiment: Base Station (e.g., eNB) Based Detection

In a fifth embodiment, building on the any of the previous embodiments, the base station (e.g., eNB) responds to an idle mode mobile originated data transmission from the device with a physical or higher layer message either confirming implicitly or explicitly, e.g. Acknowledgement (ACK), that the used TA value was valid, commanding the device to acquire a new TA value, or providing the device a new TA value, e.g. via Medium Access Control (MAC) Control Element (CE).

One example of the fifth embodiment is illustrated in FIG. 8. As illustrated, a device, which in this example is a UE, transmits an idle mode transmission to a base station using a particular TA value (step 800). The base station determines whether the UE used a valid TA value (step 802). This determination may be made using any suitable procedure. The base station transmits a transmission that explicitly or implicitly indicates that the UE used a valid (or invalid) TA configuration/value, commands the UE to acquire a new TA value, or provides a new TA value for the UE (step 804). The UE then performs one or more operations in accordance with the received transmission (step 806). For example, if the received transmission indicates that the UE used a valid TA value, then the UE may continue to use the TA value. As another example, if the transmission commands the UE to acquire a new TA value, the UE obtains a new TA value, e.g. using a conventional TA acquisition procedure. As yet another example, if the received transmission provides a new TA value, the UE uses the new TA value, e.g., to perform an idle mode transmission.

### Sixth Embodiment: UE Fallback Procedure

In a sixth embodiment, building on previous embodiments, in case the device detects that the UL data transmission attempt was unsuccessful, the UE falls back to legacy behavior where the UE performs (Narrowband)PRACH ((N)PRACH) transmission to update its UL time alignment.

The device can detect that the UL data transmission attempt was unsuccessful if the device does not receive the expected feedback in downlink from the base station (e.g., eNB), e.g. with an ACK message or scheduling a new transmission. In practice, however, it is somewhat more complicated, and the device needs to deduce that the absence of feedback was not due to other issues not related to incorrect UL synchronization of the device, i.e. due to any issue normally covered by a Hybrid Automatic Repeat Request (HARQ) retransmission (fading dips, etc.), too low output power, or due to collision in transmission (in the case of UL data transmission being contention-based). In such cases, the device needs to deduce that the failure was due to incorrect UL synchronization, and a method doing so could be based on receiving the feedback sent to the contending UE(s), basing the decision on a threshold for a number of failed access attempts, first after failing the UL data transmission with a preconfigured output power level, number of output power level ramp up based on a configured step size, or number of repetitions. For example, if the device cannot receive any feedback sent from the base station to another device winning the contention, the device could conclude that the stored TA is not correct and fallback to a random access procedure to obtain a new TA.

In an aspect of the sixth embodiment, the device informs the base station that the UL data transmission attempt using the stored UL time alignment was unsuccessful. This information can be used by the base station or by other network node(s) or by a network operator to optimize the configuration in, e.g., the fourth embodiment.

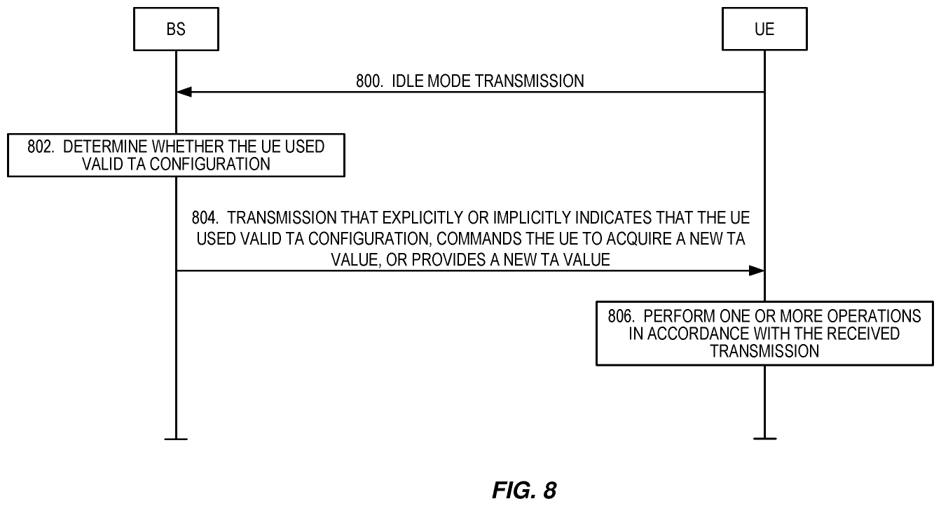

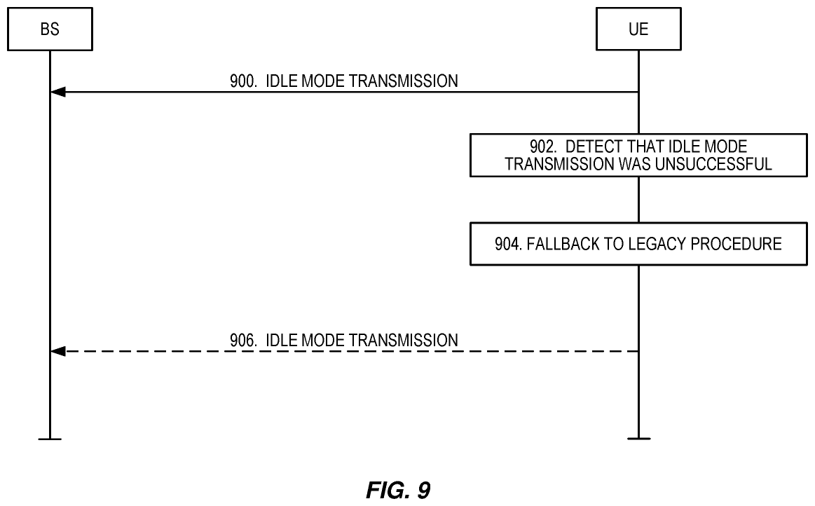

FIG. 9 illustrates the operation of a base station (e.g., eNB) and a UE in accordance with at least some aspects of the sixth embodiment. As illustrated, the UE attempts an idle mode uplink transmission using the stored TA value (step 900). In this example, the UE detects that this transmission is unsuccessful, e.g., using any of the mechanisms described above (step 902). The UE then falls back to the legacy procedure (e.g., falls back to a random access procedure to obtain a new TA value) (step 904). The UE may optionally notify the base station that the attempted transmission of step 900 was unsuccessful, as described above (step 906).

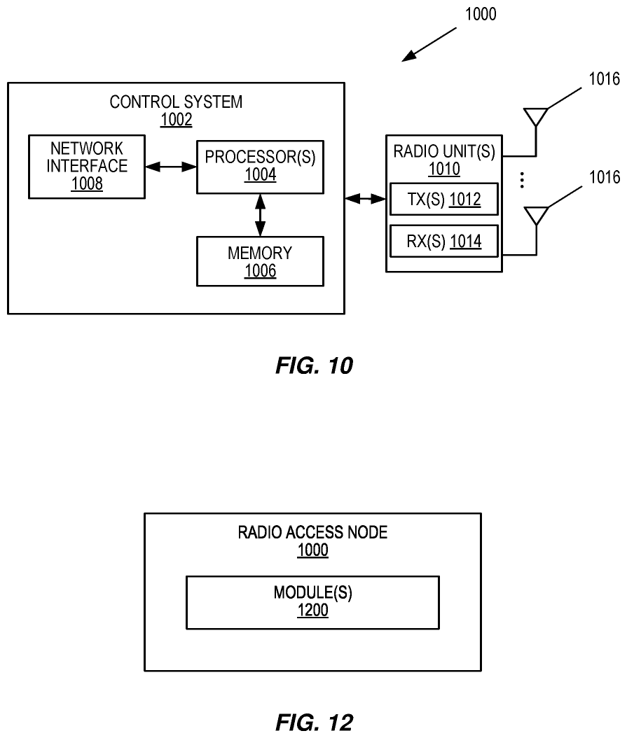

Now, the discussion turns to some additional aspects that are applicable to all of the embodiments described above. FIG. 10 is a schematic block diagram of a radio access node 1000 according to some embodiments of the present disclosure. The radio access node 1000 may be, for example, a base station 202 or 206. As illustrated, the radio access node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the radio access node 1000 includes one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 as described herein. In some embodiments, the function(s) are implemented in software that is stored, e.g., in the memory 1006 and executed by the one or more processors 1004.

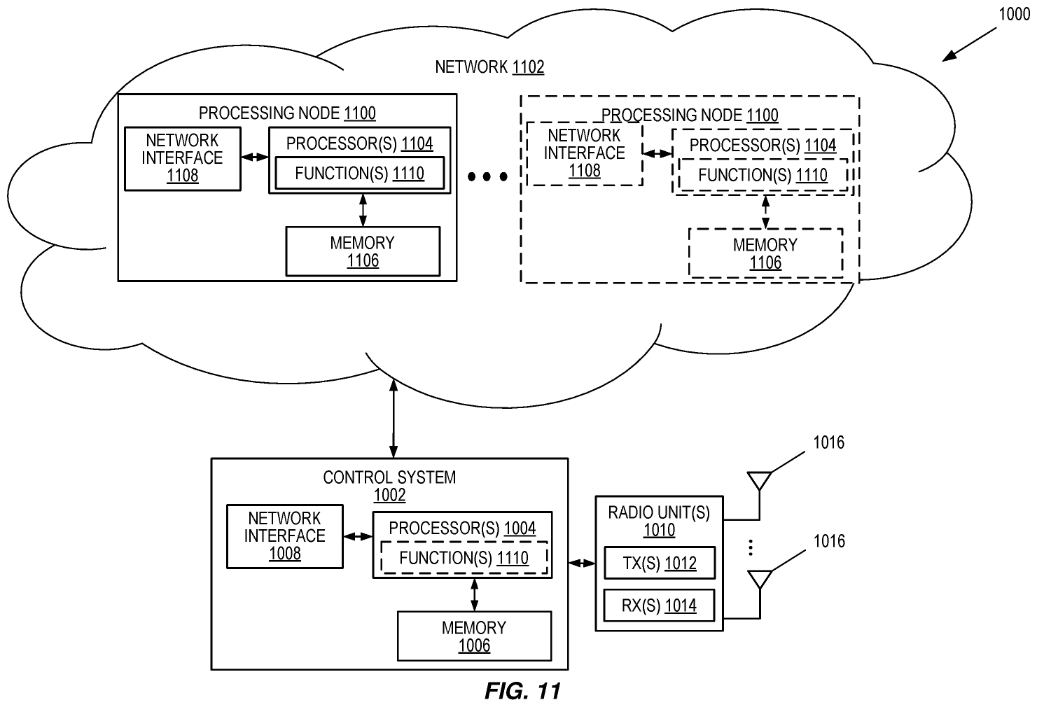

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures.

As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 includes the control system 1002 that includes the one or more processors 1004 (e.g., CPUs, ASICs, FPGAs, and/or the like), the memory 1006, and the network interface 1008 and the one or more radio units 1010 that each includes the one or more transmitters 1012 and the one or more receivers 1014 coupled to the one or more antennas 1016, as described above. The control system 1002 is connected to the radio unit(s) 1010 via, for example, an optical cable or the like. The control system 1002 is connected to one or more processing nodes 1100 coupled to or included as part of a network(s) 1102 via the network interface 1008. Each processing node 1100 includes one or more processors 1104 (e.g., CPUs, ASICs, FPGAs, and/or the like), memory 1106, and a network interface 1108.

In this example, functions 1110 of the radio access node 1000 described herein are implemented at the one or more processing nodes 1100 or distributed across the control system 1002 and the one or more processing nodes 1100 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

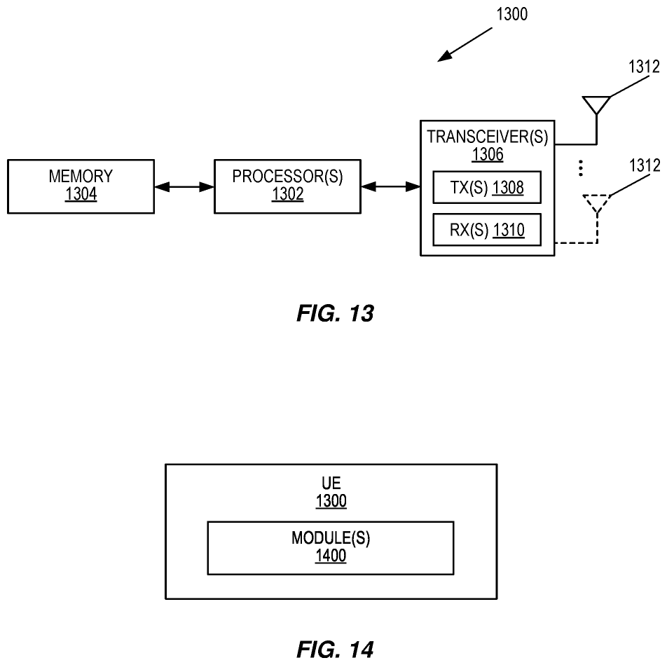

FIG. 13 is a schematic block diagram of a UE 1300 according to some embodiments of the present disclosure. As illustrated, the UE 1300 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the UE 1300 described above may be fully or partially implemented in software that is, e.g., stored in the memory 1304 and executed by the processor(s) 1302. Note that the UE 1300 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the UE 1300 and/or allowing output of information from the UE 1300), a power supply (e.g., a battery and associated power circuitry), etc.

In some embodiments, a computer program including instructions which, when executed by at least one processor, causes the at least one processor to carry out the functionality of the UE 1300 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the UE 1300 according to some other embodiments of the present disclosure. The UE 1300 includes one or more modules 1410, each of which is implemented in software. The module(s) 1410 provide the functionality of the UE 1300 described herein.

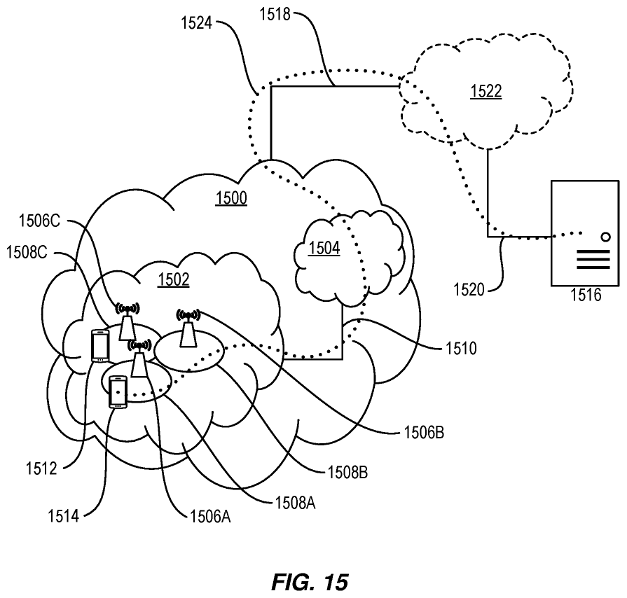

With reference to FIG. 15, in accordance with an embodiment, a communication system includes a telecommunication network 1500, such as a 3GPP-type cellular network, which comprises an access network 1502, such as a RAN, and a core network 1504. The access network 1502 comprises a plurality of base stations 1506A, 1506B, 1506C, such as Node Bs, eNBs, gNBs, or other types of wireless Access Points (APs), each defining a corresponding coverage area 1508A, 1508B, 1508C. Each base station 1506A, 1506B, 1506C is connectable to the core network 1504 over a wired or wireless connection 1510. A first UE 1512 located in coverage area 1508C is configured to wirelessly connect to, or be paged by, the corresponding base station 1506C. A second UE 1514 in coverage area 1508A is wirelessly connectable to the corresponding base station 1506A. While a plurality of UEs 1512, 1514 are illustrated in this example, the disclosed embodiments are equally applicable to a situation where a sole UE is in the coverage area or where a sole UE is connecting to the corresponding base station 1506.

The telecommunication network 1500 is itself connected to a host computer 1516, which may be embodied in the hardware and/or software of a standalone server, a cloud-implemented server, a distributed server, or as processing resources in a server farm. The host computer 1516 may be under the ownership or control of a service provider, or may be operated by the service provider or on behalf of the service provider. Connections 1518 and 1520 between the telecommunication network 1500 and the host computer 1516 may extend directly from the core network 1504 to the host computer 1516 or may go via an optional intermediate network 1522. The intermediate network 1522 may be one of, or a combination of more than one of, a public, private, or hosted network; the intermediate network 1522, if any, may be a backbone network or the Internet; in particular, the intermediate network 1522 may comprise two or more sub-networks (not shown).

The communication system of FIG. 15, as a whole, enables connectivity between the connected UEs 1512, 1514 and the host computer 1516. The connectivity may be described as an Over-the-Top (OTT) connection 1524. The host computer 1516 and the connected UEs 1512, 1514 are configured to communicate data and/or signaling via the OTT connection 1524, using the access network 1502, the core network 1504, any intermediate network 1522, and possible further infrastructure (not shown) as intermediaries. The OTT connection 1524 may be transparent in the sense that the participating communication devices through which the OTT connection 1524 passes are unaware of routing of uplink and downlink communications. For example, the base station 1506 may not or need not be informed about the past routing of an incoming downlink communication with data originating from the host computer 1516 to be forwarded (e.g., handed over) to a connected UE 1512. Similarly, the base station 1506 need not be aware of the future routing of an outgoing uplink communication originating from the UE 1512 towards the host computer 1516.

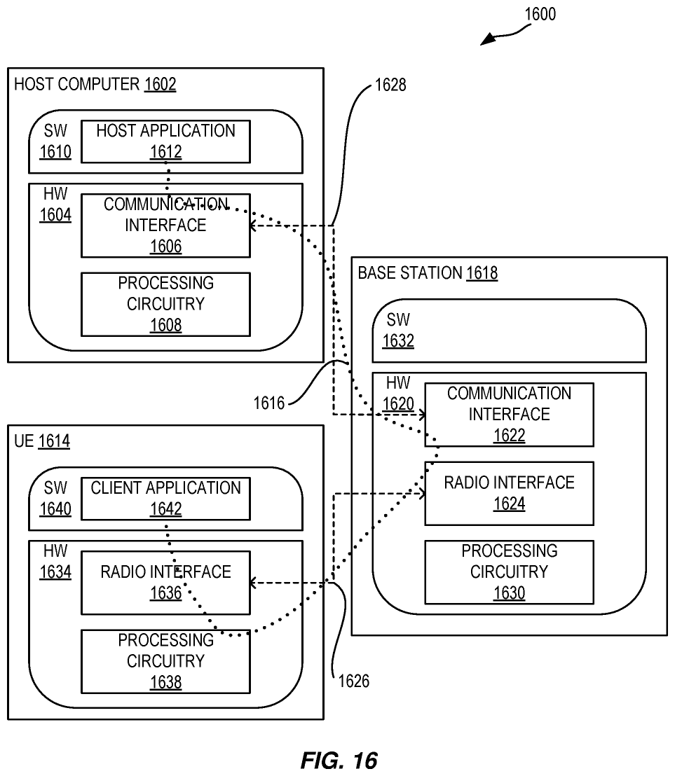

Example implementations, in accordance with an embodiment, of the UE, base station, and host computer discussed in the preceding paragraphs will now be described with reference to FIG. 16. In a communication system 1600, a host computer 1602 comprises hardware 1604 including a communication interface 1606 configured to set up and maintain a wired or wireless connection with an interface of a different communication device of the communication system 1600. The host computer 1602 further comprises processing circuitry 1608, which may have storage and/or processing capabilities. In particular, the processing circuitry 1608 may comprise one or more programmable processors, ASICs, FPGAs, or combinations of these (not shown) adapted to execute instructions. The host computer 1602 further comprises software 1610, which is stored in or accessible by the host computer 1602 and executable by the processing circuitry 1608. The software 1610 includes a host application 1612. The host application 1612 may be operable to provide a service to a remote user, such as a UE 1614 connecting via an OTT connection 1616 terminating at the UE 1614 and the host computer 1602. In providing the service to the remote user, the host application 1612 may provide user data which is transmitted using the OTT connection 1616.

The communication system 1600 further includes a base station 1618 provided in a telecommunication system and comprising hardware 1620 enabling it to communicate with the host computer 1602 and with the UE 1614. The hardware 1620 may include a communication interface 1622 for setting up and maintaining a wired or wireless connection with an interface of a different communication device of the communication system 1600, as well as a radio interface 1624 for setting up and maintaining at least a wireless connection 1626 with the UE 1614 located in a coverage area (not shown in FIG. 16) served by the base station 1618. The communication interface 1622 may be configured to facilitate a connection 1628 to the host computer 1602. The connection 1628 may be direct or it may pass through a core network (not shown in FIG. 16) of the telecommunication system and/or through one or more intermediate networks outside the telecommunication system. In the embodiment shown, the hardware 1620 of the base station 1618 further includes processing circuitry 1630, which may comprise one or more programmable processors, ASICs, FPGAs, or combinations of these (not shown) adapted to execute instructions. The base station 1618 further has software 1632 stored internally or accessible via an external connection.

The communication system 1600 further includes the UE 1614 already referred to. The UE's 1614 hardware 1634 may include a radio interface 1636 configured to set up and maintain a wireless connection 1626 with a base station serving a coverage area in which the UE 1614 is currently located. The hardware 1634 of the UE 1614 further includes processing circuitry 1638, which may comprise one or more programmable processors, ASICs, FPGAs, or combinations of these (not shown) adapted to execute instructions. The UE 1614 further comprises software 1640, which is stored in or accessible by the UE 1614 and executable by the processing circuitry 1638. The software 1640 includes a client application 1642. The client application 1642 may be operable to provide a service to a human or non-human user via the UE 1614, with the support of the host computer 1602. In the host computer 1602, the executing host application 1612 may communicate with the executing client application 1642 via the OTT connection 1616 terminating at the UE 1614 and the host computer 1602. In providing the service to the user, the client application 1642 may receive request data from the host application 1612 and provide user data in response to the request data. The OTT connection 1616 may transfer both the request data and the user data. The client application 1642 may interact with the user to generate the user data that it provides.

It is noted that the host computer 1602, the base station 1618, and the UE 1614 illustrated in FIG. 16 may be similar or identical to the host computer 1516, one of the base stations 1506A, 1506B, 1506C, and one of the UEs 1512, 1514 of FIG. 15, respectively. This is to say, the inner workings of these entities may be as shown in FIG. 16 and independently, the surrounding network topology may be that of FIG. 15.

In FIG. 16, the OTT connection 1616 has been drawn abstractly to illustrate the communication between the host computer 1602 and the UE 1614 via the base station 1618 without explicit reference to any intermediary devices and the precise routing of messages via these devices. The network infrastructure may determine the routing, which may be configured to hide from the UE 1614 or from the service provider operating the host computer 1602, or both. While the OTT connection 1616 is active, the network infrastructure may further take decisions by which it dynamically changes the routing (e.g., on the basis of load balancing consideration or reconfiguration of the network).

The wireless connection 1626 between the UE 1614 and the base station 1618 is in accordance with the teachings of the embodiments described throughout this disclosure. One or more of the various embodiments improve the performance of OTT services provided to the UE 1614 using the OTT connection 1616, in which the wireless connection 1626 forms the last segment. More precisely, the teachings of these embodiments may improve e.g., date rate, latency, and/or power consumption and thereby provide benefits such as, e.g., reduced user waiting time, relaxed restriction on file size, better responsiveness, and/or extended battery lifetime.

A measurement procedure may be provided for the purpose of monitoring data rate, latency, and other factors on which the one or more embodiments improve. There may further be an optional network functionality for reconfiguring the OTT connection 1616 between the host computer 1602 and the UE 1614, in response to variations in the measurement results. The measurement procedure and/or the network functionality for reconfiguring the OTT connection 1616 may be implemented in the software 1610 and the hardware 1604 of the host computer 1602 or in the software 1640 and the hardware 1634 of the UE 1614, or both. In some embodiments, sensors (not shown) may be deployed in or in association with communication devices through which the OTT connection 1616 passes; the sensors may participate in the measurement procedure by supplying values of the monitored quantities exemplified above, or supplying values of other physical quantities from which the software 1610, 1640 may compute or estimate the monitored quantities. The reconfiguring of the OTT connection 1616 may include message format, retransmission settings, preferred routing, etc.; the reconfiguring need not affect the base station 1618, and it may be unknown or imperceptible to the base station 1618. Such procedures and functionalities may be known and practiced in the art. In certain embodiments, measurements may involve proprietary UE signaling facilitating the host computer 1602's measurements of throughput, propagation times, latency, and the like. The measurements may be implemented in that the software 1610 and 1640 causes messages to be transmitted, in particular empty or ‘dummy’ messages, using the OTT connection 1616 while it monitors propagation times, errors, etc.

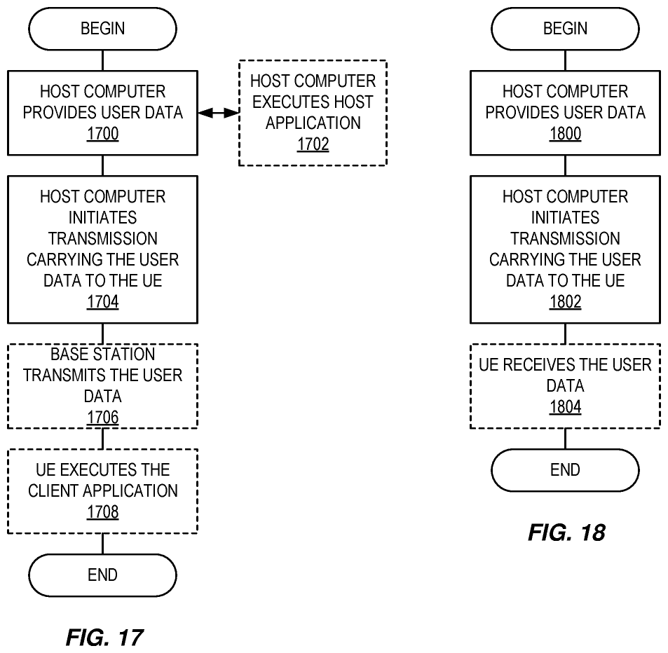

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700, the host computer provides user data. In sub-step 1702 (which may be optional) of step 1700, the host computer provides the user data by executing a host application. In step 1704, the host computer initiates a transmission carrying the user data to the UE. In step 1706 (which may be optional), the base station transmits to the UE the user data which was carried in the transmission that the host computer initiated, in accordance with the teachings of the embodiments described throughout this disclosure. In step 1708 (which may also be optional), the UE executes a client application associated with the host application executed by the host computer.

FIG. 18 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 18 will be included in this section. In step 1800 of the method, the host computer provides user data. In an optional sub-step (not shown) the host computer provides the user data by executing a host application. In step 1802, the host computer initiates a transmission carrying the user data to the UE. The transmission may pass via the base station, in accordance with the teachings of the embodiments described throughout this disclosure. In step 1804 (which may be optional), the UE receives the user data carried in the transmission.

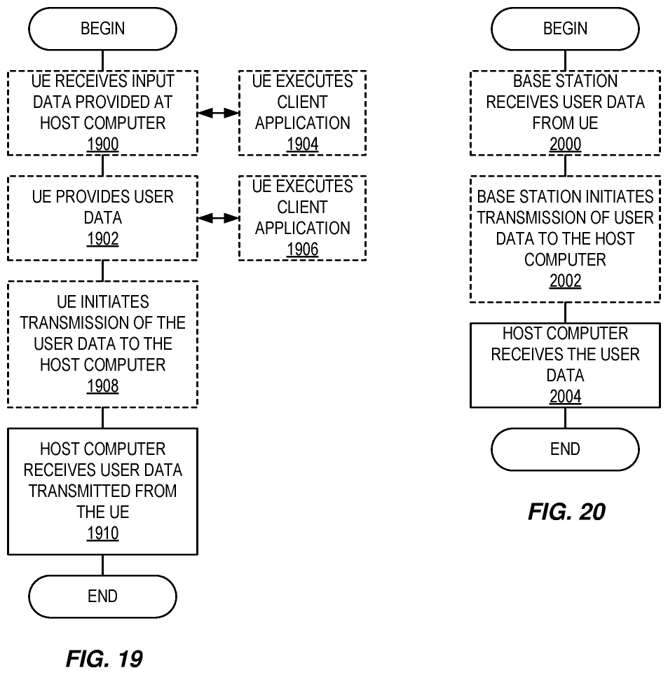

FIG. 19 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 18 will be included in this section. In step 1900 (which may be optional), the UE receives input data provided by the host computer. Additionally or alternatively, in step 1902, the UE provides user data. In sub-step 1904 (which may be optional) of step 1900, the UE provides the user data by executing a client application. In sub-step 1906 (which may be optional) of step 1902, the UE executes a client application which provides the user data in reaction to the received input data provided by the host computer. In providing the user data, the executed client application may further consider user input received from the user. Regardless of the specific manner in which the user data was provided, the UE initiates, in sub-step 1908 (which may be optional), transmission of the user data to the host computer. In step 1910 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 20 will be included in this section. In step 2000 (which may be optional), in accordance with the teachings of the embodiments described throughout this disclosure, the base station receives user data from the UE. In step 2002 (which may be optional), the base station initiates transmission of the received user data to the host computer. In step 2004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows.

### Group A Embodiments

Embodiment 1: A method performed by a wireless device, the method comprising: measuring (300) a reference time of arrival, TOA_{REF}(T₀), value for a reference base station for a time T₀ at which the wireless device has a valid timing advance, TA(T₀), value; measuring (302), time of arrival, TOA_{X}(T₀), values for a set of one or more other base stations {BS_{X}} for the time T₀; computing and storing (304) time difference of arrival, TDOA_{X}(T₀), values for the set of one or more other base stations {BS_{X}} for the time T₀; measuring (306) a reference time of arrival, TOA_{REF}(T₁), value for the reference base station for a time T₁, the time T₁ being a time at which the wireless device is in idle mode; measuring (308) time of arrival, TOA_{X}(T₁), values for the set of one or more other base stations {BS_{X}} for the time T₁; computing (310) time difference of arrival, TDOA_{X}(T₁), values for the set of one or more other base stations {BS_{X}} for the time T₁; and determining (312) whether the TA(T₀) value is valid at the time T₁ based on the TDOA_{X}(T₀) values for the set of one or more other base stations {BS_{X}} for the time T₀ and the TOA_{X}(T₁) values for the set of one or more other base stations {BS_{X}} for the time T₁.

Embodiment 2: The method of embodiment 1 wherein determining (312) whether the TA(T₀) value is valid at the time T₁ comprises determining (312) that the TA(T₀) value is valid at the time T₁.

Embodiment 3: The method of embodiment 2 further comprising performing (314) an idle mode uplink transmission using the TA(T₀) value upon determining (312) that the TA(T₀) value is valid at the time T₁.

Embodiment 4: The method of any one of embodiments 1 to 3 wherein the time T₀ is a time at which the wireless device is in connected mode.

Embodiment 5: The method of any one of embodiments 1 to 4 wherein determining (312) whether the TA(T₀) value is valid at the time T₁ comprises: computing (400) differential time difference of arrival, dTDOA_{X}(T₁), values for the set of one or more other base stations {BS_{X}} for the time T₁, wherein for each other base station BS_{X} of the set of one or more other base stations {BS_{X}}, the dTDOA_{X}(T₁) value is computed as a difference between the TDOA_{X}(T₁) value for the BS_{X} and the TDOA_{X}(T₀) value for the BS_{X}; finding (402) a maximum value from among the dTDOA_{X}(T₁) values, or absolute values of the dTDOA_{X}(T₁) values, for the set of one or more other base stations {BS_{X}} for the time T₁; and determining (404, 406) whether the TA(T₀) value is valid at the time T₁ based on the maximum value.

Embodiment 6: The method of embodiment 5 wherein determining (404, 406) whether the TA(T₀) value is valid at the time T₁ based on the maximum value comprises determining (404) whether the maximum value is less than a predefined or configured threshold.

Embodiment 7: The method of embodiment 6 further comprising determining (406) that the TA(T₀) value is valid at the time T₁ if the maximum value is less than the predefined or configured threshold.

Embodiment 8: The method of any one of embodiments 5 to 7 further comprising determining (408) that the TA(T₀) value is not valid at the time T₁ if the maximum value is greater than the predefined or configured threshold.

Embodiment 9: The method of any one of embodiments 1 to 4 wherein determining (312) whether the TA(T₀) value is valid at the time T₁ comprises: computing (500) differential time difference of arrival, dTDOA_{X}(T₁), values for the set of one or more other base stations {BS_{X}} for the time T₁, wherein for each other base station BS_{X} of the set of one or more other base stations {BS_{X}}, the dTDOA_{X}(T₁) value is computed as a difference between the TDOA_{X}(T₁) value for the BS_{X} and the TDOA_{X}(T₀) value for the BS_{X}; computing (502) a mean, standard deviation, or variance of the dTDOA_{X}(T₁) values; and determining (504, 506) whether the TA(T₀) value is valid at the time T₁ based on the mean, standard deviation, or variance of the dTDOA_{X}(T₁) values.

Embodiment 10: The method of embodiment 9 wherein determining (504, 506) whether the TA(T₀) value is valid at the time T₁ based on the mean, standard deviation, or variance of the dTDOA_{X}(T₁) values comprises determining (504) whether the mean, standard deviation, or variance of the dTDOA_{X}(T₁) values is less than a predefined or configured threshold.

Embodiment 11: The method of embodiment 10 further comprising determining (506) that the TA(T₀) value is valid at the time T₁ if the mean, standard deviation, or variance of the dTDOA_{X}(T_{I}) values is less than the predefined or configured threshold.

Embodiment 12: The method of any one of embodiments 9 to 11 further comprising determining (508) that the TA(T₀) value is not valid at the time T₁ if the mean, standard deviation, or variance of the dTDOA_{X}(T₁) values is greater than the predefined or configured threshold.

Embodiment 13: The method of any one of embodiments 1 to 12 wherein: the TOA_{REF}(T₀) value is an averaged value over time and/or frequency; the TOA_{X}(T₀) values are averaged values over time and/or frequency; the TOA_{REF}(T₁) value is an averaged value over time and/or frequency; and/or the TOA_{X}(T_{I}) values are averaged values over time and/or frequency.

Embodiment 14: A method performed by a wireless device, the method comprising: obtaining (600) a distance that the wireless device has moved between a time T₀ at which the wireless device has a valid timing advance, TA(T₀), value and a time T₁; and determining (602, 604) whether the TA(T₀) value is valid at the time T₁ based on the distance.

Embodiment 15: The method of embodiment 14 wherein determining (602, 604) whether the TA(T₀) value is valid at the time T₁ comprises determining (604) that the TA(T₀) value is valid at the time T₁.

Embodiment 16: The method of embodiment 15 further comprising performing an idle mode uplink transmission using the TA(T₀) value upon determining (604) that the TA(T₀) value is valid at the time T₁.

Embodiment 17: The method of any one of embodiments 14 to 16 wherein determining (602, 604) whether the TA(T₀) value is valid at the time T₁ based on the distance comprises determining (602) whether the distance is less than a predefined or configured threshold.

Embodiment 18: The method of embodiment 17 further comprising determining (604) that the TA(T₀) value is valid at the time T₁ if the distance is less than the predefined or configured threshold.

Embodiment 19: The method of any one of embodiments 16 to 18 further comprising determining (606) that the TA(T₀) value is not valid at the time T₁ if the distance is greater than the predefined or configured threshold.

Embodiment 20: The method of any one of embodiments 14 to 19 wherein the wireless device is in connected mode at the time T₀ and in idle mode at the time T₁.

Embodiment 21: A method performed by a wireless device, the method comprising: receiving, from a network node, an indication as to whether the wireless device is to determine Timing Advance (TA) validity when in idle mode using a Time Difference of Arrival, TDOA, scheme or a distance scheme; f the indication indicates that the wireless device is to use the TDOA scheme, performing the method of any one of embodiments 1 to 13; and if the indication indicates that the wireless device is to use the distance scheme, performing the method of any one of embodiments 14 to 20.

Embodiment 22: A method performed by a wireless device, the method comprising: performing (700) an idle mode transmission using a particular Timing Advance (TA) value; receiving (704) a transmission from a base station that explicitly or implicitly indicates whether the particular TA value is valid, commands the wireless device to acquire a new TA value, or provides a new TA value; and performing (706) one or more operations in accordance with the received transmission.

Embodiment 23: The method of embodiment 22 wherein: performing (700) the idle mode transmission comprises performing (700) the idle mode transmission at a time T₁ at which the wireless device is in idle mode; and the particular TA value is a TA value, TA(T₀), obtained by the wireless device at a time T₀ when the wireless device is in connected mode.

Embodiment 24: The method of embodiment 22 or 23 wherein: the transmission indicates that the particular TA value is invalid; and performing (706) the one or more operations comprises obtaining a new TA value.

Embodiment 25: The method of embodiment 24 wherein obtaining the new TA value comprises obtaining a new TA value using a conventional scheme.

Embodiment 26: The method of any one of embodiments 1 to 25 wherein the wireless device is a Narrowband Internet of Things (NB-IoT), User Equipment (UE), or a Long Term Evolution Machine Type Communication (LTE-M) UE.

Embodiment 27: The method of any of the previous embodiments, further comprising: providing user data; and forwarding the user data to a host computer via the transmission to the base station.

### Group B Embodiments

Embodiment 28: A method performed by a base station, the method comprising: transmitting, to a wireless device, an indication as to whether the wireless device is to determine Timing Advance (TA) validity when in idle mode using a Time Difference of Arrival (TDOA) scheme or a distance scheme.

Embodiment 29: A method performed by a base station, the method comprising: receiving (700) an idle mode transmission from a wireless device; determining (702) whether the wireless device used a valid Timing Advance (TA) value for the idle mode transmission; and transmitting (704) a transmission to the wireless device that explicitly or implicitly indicates whether a particular TA value is valid, commands the wireless device to acquire a new TA value, or provides a new TA value, based on the determination of whether the wireless device used a valid TA value for the idle mode transmission.

Embodiment 30: The method of any of the previous embodiments, further comprising: obtaining user data; and forwarding the user data to a host computer or a wireless device.

### Group C Embodiments

Embodiment 31: A wireless device, the wireless device comprising: processing circuitry configured to perform any of the steps of any of the Group A embodiments; and power supply circuitry configured to supply power to the wireless device.

Embodiment 32: A base station, the base station comprising: processing circuitry configured to perform any of the steps of any of the Group B embodiments; and power supply circuitry configured to supply power to the base station.

Embodiment 33: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 34: A communication system including a host computer comprising: processing circuitry configured to provide user data; and a communication interface configured to forward the user data to a cellular network for transmission to a user equipment, UE; wherein the cellular network comprises a base station having a radio interface and processing circuitry, the base station's processing circuitry configured to perform any of the steps of any of the Group B embodiments.

Embodiment 35: The communication system of the previous embodiment further including the base station.

Embodiment 36: The communication system of the previous 2 embodiments, further including the UE, wherein the UE is configured to communicate with the base station.

Embodiment 37: The communication system of the previous 3 embodiments, wherein: the processing circuitry of the host computer is configured to execute a host application, thereby providing the user data; and the UE comprises processing circuitry configured to execute a client application associated with the host application.

Embodiment 38: A method implemented in a communication system including a host computer, a base station, and a user equipment (UE) the method comprising: at the host computer, providing user data; and at the host computer, initiating a transmission carrying the user data to the UE via a cellular network comprising the base station, wherein the base station performs any of the steps of any of the Group B embodiments.

Embodiment 39: The method of the previous embodiment, further comprising, at the base station, transmitting the user data.

Embodiment 40: The method of the previous 2 embodiments, wherein the user data is provided at the host computer by executing a host application, the method further comprising, at the UE, executing a client application associated with the host application.

Embodiment 41: A user equipment (UE) configured to communicate with a base station, the UE comprising a radio interface and processing circuitry configured to perform the method of the previous 3 embodiments.

Embodiment 42: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 43: The communication system of the previous embodiment, wherein the cellular network further includes a base station configured to communicate with the UE.

Embodiment 44: The communication system of the previous 2 embodiments, wherein: the processing circuitry of the host computer is configured to execute a host application, thereby providing the user data; and the UE's processing circuitry is configured to execute a client application associated with the host application.

Embodiment 45: A method implemented in a communication system including a host computer, a base station, and a User Equipment (UE) the method comprising: at the host computer, providing user data; and at the host computer, initiating a transmission carrying the user data to the UE via a cellular network comprising the base station, wherein the UE performs any of the steps of any of the Group A embodiments.

Embodiment 46: The method of the previous embodiment, further comprising at the UE, receiving the user data from the base station.

Embodiment 47: A communication system including a host computer comprising: communication interface configured to receive user data originating from a transmission from a User Equipment (UE) to a base station; wherein the UE comprises a radio interface and processing circuitry, the UE's processing circuitry configured to perform any of the steps of any of the Group A embodiments.

Embodiment 48: The communication system of the previous embodiment, further including the UE.

Embodiment 49: The communication system of the previous 2 embodiments, further including the base station, wherein the base station comprises a radio interface configured to communicate with the UE and a communication interface configured to forward to the host computer the user data carried by a transmission from the UE to the base station.

Embodiment 50: The communication system of the previous 3 embodiments, wherein: the processing circuitry of the host computer is configured to execute a host application; and the UE's processing circuitry is configured to execute a client application associated with the host application, thereby providing the user data.

Embodiment 51: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 52: A method implemented in a communication system including a host computer, a base station, and a User Equipment (UE) the method comprising: at the host computer, receiving user data transmitted to the base station from the UE, wherein the UE performs any of the steps of any of the Group A embodiments.

Embodiment 53: The method of the previous embodiment, further comprising, at the UE, providing the user data to the base station.

Embodiment 54: The method of the previous 2 embodiments, further comprising: at the UE, executing a client application, thereby providing the user data to be transmitted; and at the host computer, executing a host application associated with the client application.

Embodiment 55: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 56: A communication system including a host computer comprising a communication interface configured to receive user data originating from a transmission from a User Equipment (UE) to a base station, wherein the base station comprises a radio interface and processing circuitry, the base station's processing circuitry configured to perform any of the steps of any of the Group B embodiments.

Embodiment 57: The communication system of the previous embodiment further including the base station.

Embodiment 58: The communication system of the previous 2 embodiments, further including the UE, wherein the UE is configured to communicate with the base station.

Embodiment 59: The communication system of the previous 3 embodiments, wherein: the processing circuitry of the host computer is configured to execute a host application; and the UE is configured to execute a client application associated with the host application, thereby providing the user data to be received by the host computer.

Embodiment 60: A method implemented in a communication system including a host computer, a base station, and a User Equipment (UE) the method comprising: at the host computer, receiving, from the base station, user data originating from a transmission which the base station has received from the UE, wherein the UE performs any of the steps of any of the Group A embodiments.

Embodiment 61: The method of the previous embodiment, further comprising at the base station, receiving the user data from the UE.

Embodiment 62: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
μs Microsecond
3GPP Third Generation Partnership Project
5G Fifth Generation
ACK Acknowledgement
AP Access Point
ASIC Application Specific Integrated Circuit
CE Control Element
CP Cyclic Prefix
CPU Central Processing Unit
CRS Common Reference Signal
DL Downlink
DSP Digital Signal Processor
eNB Enhanced or Evolved Node B
FPGA Field Programmable Gate Array
gNB New Radio Base Station
GPS Global Positioning System
HARQ Hybrid Automatic Repeat Request
LTE Long Term Evolution
LTE-M Long Term Evolution Machine Type Communication
MAC Medium Access Control
MME Mobility Management Entity
MTC Machine Type Communication
NB-IoT Narrowband Internet of Things
NPRACH Narrowband Physical Random Access Channel
NPSS Narrowband Primary Synchronization Signal
NR New Radio
NRS Narrowband Reference Signal
NSSS Narrowband Secondary Synchronization Signal
OTT Over-the-Top
P-GW Packet Data Network Gateway
PRACH Physical Random Access Channel
PRS Positioning Reference Signal
PSS Primary Synchronization Signal
RAM Random Access Memory
RAN Radio Access Network
RAR Random Access Response
RAT Radio Access Technology
ROM Read Only Memory
RRH Remote Radio Head
RS Reference Signal
RSS Resynchronization Signal
RTT Round Trip Time
SCEF Service Capability Exposure Function
SSS Secondary Synchronization Signal
TA Timing Advance
TDOA Time Difference of Arrival
TOA Time of Arrival
TS Technical Specification
UE User Equipment
UL Uplink
WID Work Item Description

Those skilled in the art will recognize improvements and modifications to the embodiments of the present disclosure. All such improvements and modifications are considered within the scope of the concepts disclosed herein.

1. A method performed by a wireless device, the method comprising:
measuring a reference time of arrival, TOA_{REF}(T₀), value for a reference base station for a time T₀ at which the wireless device has a valid timing advance, TA(T₀), value;
measuring time of arrival, TOA_{X}(T₀), values for a set of one or more other base stations for the time T₀;
computing and storing time difference of arrival, TDOA_{X}(T₀), values for the set of one or more other base stations for the time T₀;
measuring a reference time of arrival, TOA_{REF}(T₁), value for the reference base station for a time T₁, the time T₁ being after the time T₀;
measuring time of arrival, TOA_{X}(T₁), values for the set of one or more other base stations for the time T₁;
computing time difference of arrival, TDOA_{X}(T₁), values for the set of one or more other base stations for the time T₁; and
determining whether the TA(T₀) value is valid at the time T₁ based on the TDOA_{X}(T₀) values for the set of one or more other base stations for the time T₀ and the TDOA_{X}(T₁) values for the set of one or more other base stations for the time T₁.

2. The method of claim 1 wherein the time T₁ is a time at which the wireless device is in idle mode.

3. The method of claim 1 wherein determining whether the TA(T₀) value is valid at the time T₁ comprises determining that the TA(T₀) value is valid at the time T₁.

4. The method of claim 3 further comprising performing an idle mode uplink transmission using the TA(T₀) value upon determining that the TA(T₀) value is valid at the time T₁.

5. The method of claim 1 wherein the time T₀ is a time at which the wireless device checked that its timing advance was valid for providing synchronized uplink access.

6. The method of claim 1 wherein determining whether the TA(T₀) value is valid at the time T₁ comprises:
computing differential time difference of arrival, dTDOA_{X}(T₁), values for the set of one or more other base stations for the time T₁, wherein for each other base station of the set of one or more other base stations, the dTDOA_{X}(T₁) value is computed as a difference between the TDOA_{X}(T₁) value for the other base station and the TDOA_{X}(T₀) value for the other base station;
finding a maximum value from among the dTDOA_{X}(T₁) values, or absolute values of the dTDOA_{X}(T₁) values, for the set of one or more other base stations for the time T₁; and
determining whether the TA(T₀) value is valid at the time T₁ based on the maximum value.

7. The method of claim 6 wherein determining whether the TA(T₀) value is valid at the time T₁ based on the maximum value comprises determining whether the maximum value is less than a predefined or configured threshold.

8. The method of claim 7 wherein determining whether the TA(T₀) value is valid at the time T₁ based on the maximum value further comprises determining that the TA(T₀) value is valid at the time T₁ if the maximum value is less than the predefined or configured threshold.

9. The method of claim 7 wherein determining whether the TA(T₀) value is valid at the time T₁ based on the maximum value further comprises determining that the TA(T₀) value is not valid at the time T₁ if the maximum value is greater than the predefined or configured threshold.

10. The method of claim 1 wherein determining whether the TA(T₀) value is valid at the time T₁ comprises:
computing differential time difference of arrival, dTDOA_{X}(T₁), values for the set of one or more other base stations for the time T₁, wherein for each other base station of the set of one or more other base stations, the dTDOA_{X}(T₁) value is computed as a difference between the TDOA_{X}(T₁) value for the other base station and the TDOA_{X}(T₀) value for the other base station;
computing a mean, standard deviation, or variance of the dTDOA_{X}(T₁) values; and
determining whether the TA(T₀) value is valid at the time T₁ based on the mean, standard deviation, or variance of the dTDOA_{X}(T₁) values.

11. The method of claim 10 wherein determining whether the TA(T₀) value is valid at the time T₁ based on the mean, standard deviation, or variance of the dTDOA_{X}(T₁) values comprises determining whether the mean, standard deviation, or variance of the dTDOA_{X}(T₁) values is less than a predefined or configured threshold.

12. The method of claim 11 wherein determining whether the TA(T₀) value is valid at the time T₁ based on the mean, standard deviation, or variance of the dTDOA_{X}(T₁) values further comprises determining that the TA(T₀) value is valid at the time T₁ if the mean, standard deviation, or variance of the dTDOA_{X}(T₁) values is less than the predefined or configured threshold.

13. The method of claim 11 wherein determining whether the TA(T₀) value is valid at the time T₁ based on the mean, standard deviation, or variance of the dTDOA_{X}(T₁) values further comprises determining that the TA(T₀) value is not valid at the time T₁ if the mean, standard deviation, or variance of the dTDOA_{X}(T₁) values is greater than the predefined or configured threshold.

14. The method of claim 1 wherein:
the TOA_{REF}(T₀) value is an averaged value over time and/or frequency;
the TOA_{X}(T₀) values are averaged values over time and/or frequency;
the TOA_{REF}(T₁) value is an averaged value over time and/or frequency; and/or
the TOA_{X}(T₁) values are averaged values over time and/or frequency.

15. The method of claim 1 wherein the wireless device is a Narrowband Internet of Things, NB-IoT, User Equipment, UE, a Long Term Evolution Machine Type Communication, LTE-M, UE, or a New Radio, NR, UE.

16-17. (canceled)

18. A wireless device comprising:
one or more transmitters;
one or more receivers; and
processing circuitry associated with the one or more transmitters and the one or more receivers, the processing circuitry configured to cause the wireless device to:
measure a reference time of arrival, TOA_{REF}(T₀), value for a reference base station for a time T₀ at which the wireless device has a valid timing advance, TA(T₀), value;
measure time of arrival, TOA_{X}(T₀), values for a set of one or more other base stations for the time T₀;
compute and store time difference of arrival, TDOA_{X}(T₀), values for the set of one or more other base stations for the time T₀;
measure a reference time of arrival, TOA_{REF}(T₁), value for the reference base station for the time T₁;
measure time of arrival, TOA_{X}(T₁), values for the set of one or more other base stations for the time T₁;
compute time difference of arrival, TDOA_{X}(T₁), values for the set of one or more other base stations for the time T₁; and
determine whether the TA(T₀) value is valid at the time T₁ based on the TDOA_{X}(T₀) values for the set of one or more other base stations for the time T₀ and the TDOA_{X}(T₁) values for the set of one or more other base stations for the time T₁.

19. A method performed by a wireless device, the method comprising:
obtaining a distance that the wireless device has moved between a time T₀ at which the wireless device has a valid timing advance, TA(T₀), value and a time T₁; and
determining whether the TA(T₀) value is valid at the time T₁ based on the distance.

20. The method of claim 19 wherein determining whether the TA(T₀) value is valid at the time T₁ comprises determining that the TA(T₀) value is valid at the time T₁.

21. The method of claim 20 further comprising performing an idle mode uplink transmission using the TA(T₀) value upon determining that the TA(T₀) value is valid at the time T₁.

22. The method of claim 19 wherein determining whether the TA(T₀) value is valid at the time T₁ based on the distance comprises determining whether the distance is less than a predefined or configured threshold.

23. The method of claim 22 wherein determining whether the TA(T₀) value is valid at the time T₁ based on the distance further comprises determining that the TA(T₀) value is valid at the time T₁ if the distance is less than the predefined or configured threshold.

24. The method of claim 22 wherein determining whether the TA(T₀) value is valid at the time T₁ based on the distance further comprises determining that the TA(T₀) value is not valid at the time T₁ if the distance is greater than the predefined or configured threshold.

25. The method of claim 19 wherein the wireless device is in connected mode at the time T₀ and in idle mode at the time T₁.

26. The method of claim 19 wherein the wireless device is a Narrowband Internet of Things, NB-IoT, User Equipment, UE, a Long Term Evolution Machine Type Communication, LTE-M, UE, or a New Radio, NR, UE.

27-46. (canceled)
